(19) United States
(12) Patent Application Publication
(10) Pub. No.: US 2018/0316926 A1
(43) Pub. Date: Nov. 1, 2018

(54) TRANSCODING STREAMED FILM

(71) Applicant: OWNZONES Media Network, Inc., Phoenix, AZ (US)

(72) Inventor: Kevin Freund, West Hills, CA (US)

(21) Appl. No.: 15/498,329

(22) Filed: Apr. 26, 2017

(51) Int. Cl. H04N 19/40; H04N 19/70

(52) U.S. Cl. CPC H04N 19/40; H04N 19/172; H04N 19/70

(57) ABSTRACT

Systems and methods for transcoding streamed film. Exemplary methods include: receiving a video file streamed from a content owner over a network, the streaming video file being encoded using a first codec; creating an output file in cloud storage; writing a header to the output file; receiving a frame of the streaming video file from a network interface; providing the frame to a transcoder; receiving the transcoded frame from the transcoder; writing the transcoded frame to the output file; receiving another frame of the streaming video file from the network interface; providing the another frame to the transcoder; receiving the another transcoded frame from the transcoder; writing the another transcoded frame to the output file; writing an index to the output file; writing a footer to the output file; and updating the header in the output file.

### TECHNICAL FIELD

The present technology relates generally to digital video and audio, and more specifically to video and audio transcoding.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A film (also referred to as motion picture, movie, etc.), includes a series of still images which, when shown on a screen, create the illusion of moving images. Films were originally recorded onto plastic film through a photochemical process and then shown through a movie projector onto a large screen. Owners of a film, referred to as content owners, maintained one or more copies of a film referred to as a master. Masters were large reels of plastic film stored in a temperature-controlled vault for safekeeping. Masters can presently be maintained in a digital format.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to various systems and methods for transcoding streamed film. Specifically, a method for transcoding streamed film may comprise: receiving a video file streamed from a content owner over a network, the streaming video file being encoded using a first codec; determining metadata of the streaming video file; creating an output file in cloud storage; writing a header to the output file; receiving a frame of the streaming video file from a network interface; providing the frame to a transcoder, the transcoder decoding the frame using the first codec and encoding the frame using a second codec to generate a transcoded frame; receiving the transcoded frame from the transcoder; writing the transcoded frame to the output file; receiving another frame of the streaming video file from the network interface; providing the another frame to the transcoder, the transcoder decoding the another frame using the first codec and encoding the another frame using the second codec to generate another transcoded frame; receiving the another transcoded frame from the transcoder; writing the another transcoded frame to the output file; determining the another frame is a last frame of the streaming video file; writing an index to the output file; writing a footer to the output file; and updating the header in the output file.

### BRIEF DESCRIPTION OF THE DRAWINGS

Embodiments are illustrated by way of example, and not by limitation, in the figures of the accompanying drawings, in which like references indicate similar elements and in which:

FIG. 1 is a simplified representation of a film, according to some embodiments.

FIG. 2 is a simplified block diagram of a computing system for transcoding streaming film, according to various embodiments.

FIG. 3 is a simplified block diagram of a cloud-based computing system for transcoding streaming film, in accordance with some embodiments.

FIGS. 4A and 4B depict a flow diagram for a method for transcoding streaming film.

FIG. 5 is a simplified representation of a header and/or footer, according to some embodiments.

FIG. 6 is a simplified block diagram of a computing system, according to various embodiments.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/ or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

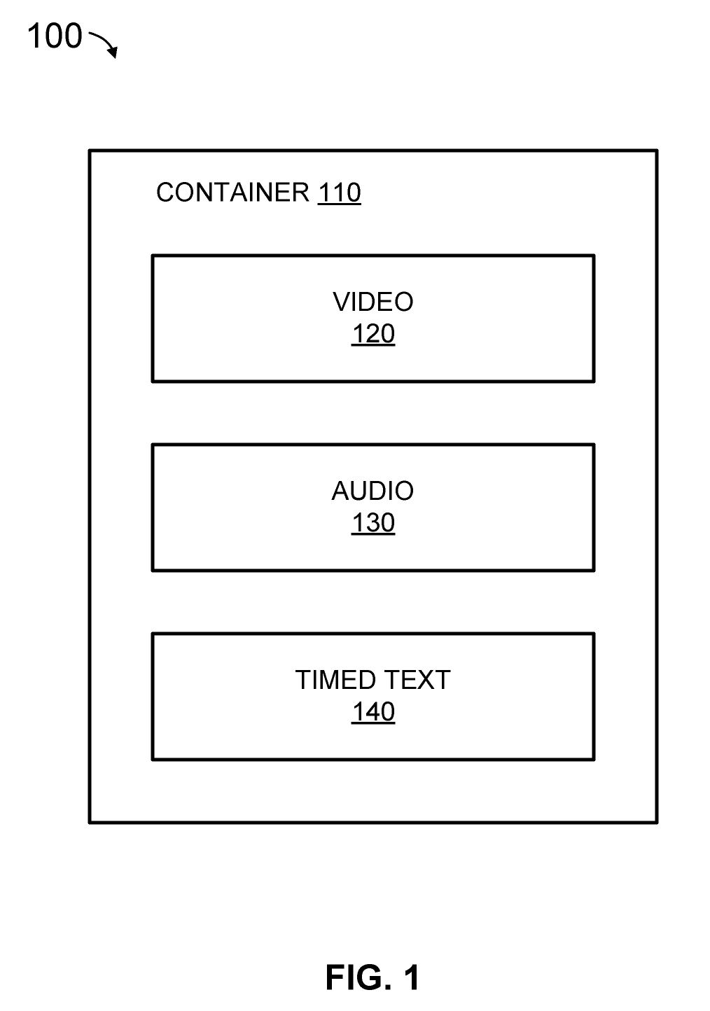

FIG. 1 depicts a film 100 (also referred to as motion picture, movie, etc.) comprising digital files. Digital files of film 100 can include video 120, audio 130, and timed text 140. Video 120 can be a series of still images which, when displayed, create the illusion of moving images. Video 120 can be encoded (e.g., compressed). For example, video 120 can be encoded using an H.264/MPEG-4 AVC, Windows Media Video (WMV), Apple ProRes, JPEG 2000 (JP2; ISO/IEC 15444), and the like video codec.

Audio 130 can be a soundtrack of speech, music and sound effects synchronized with the images (e.g., action) of video 120. Audio 130 can be encoded (e.g., compressed). For example, audio 130 can be encoded using an Advanced Audio Coding (AAC), FLAC (Free Lossless Audio Codec), MPEG-1 or MPEG-2 Audio Layer III (MP3), and the like audio codec. Timed text 140 can be text displayed with video 120 at a particular time in video 120. For example, timed text 140 can be subtitles (e.g., in the language associated with audio 130 and/or a different language(s)), closed captioning (e.g., in the language associated with audio 130 and/or a different language(s), including descriptions of non-speech elements, etc.).

In some embodiments, the digital files (e.g., video 120, audio 130, and timed text 140) are in container 110. Container 110 can be a computer file holding/wrapping the digital files and include metadata describing how different elements of the digital file data and metadata coexist in the container. By way of non-limiting example, container 110 can be an Audio Video Interleaved (AVI), Flash Video (FLV), Matroska (MKV), QuickTime, MP4, Ogg, and the like container.

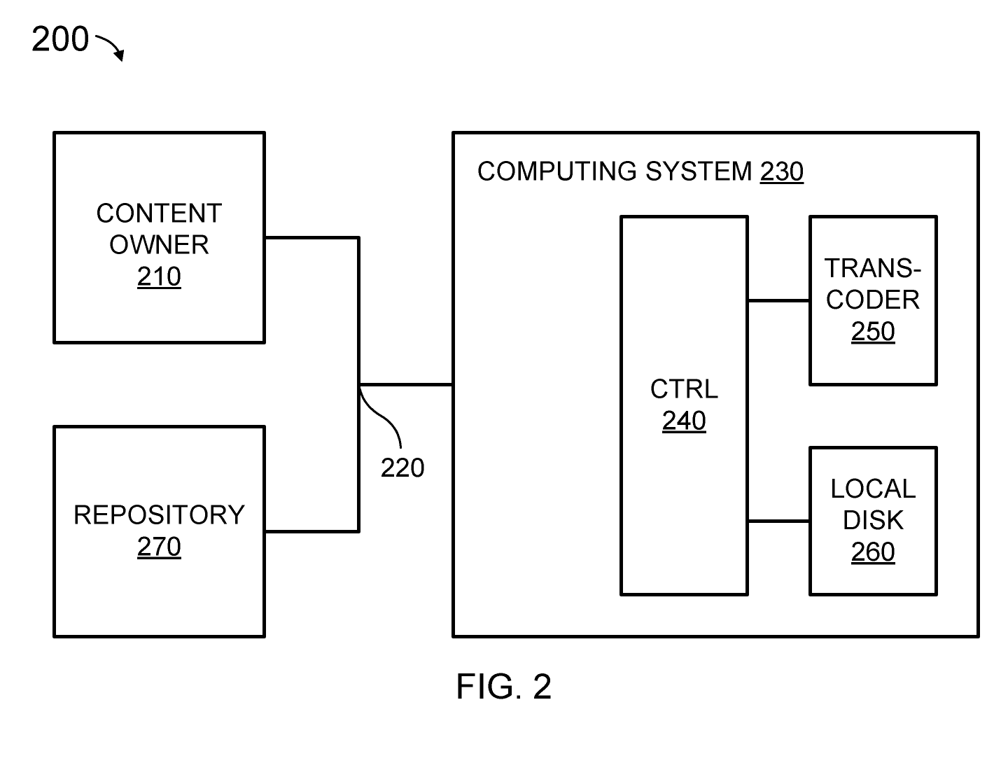

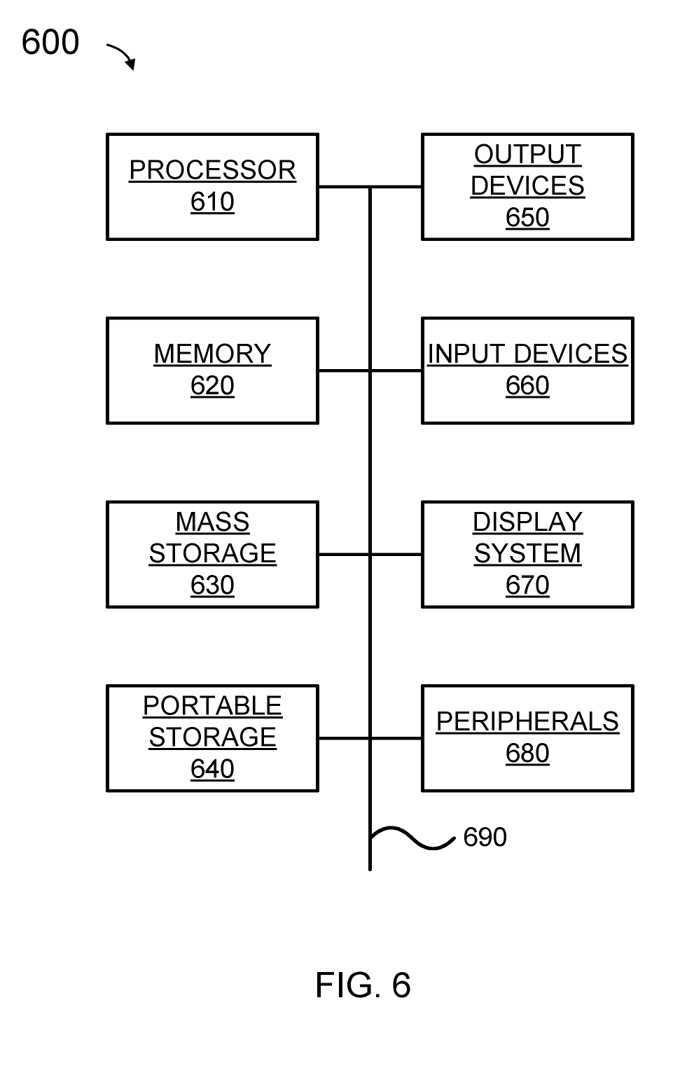

FIG. 2 illustrates system 200 for transcoding digital files (e.g., video 120, audio 130, and timed text 140 of film 100 in FIG. 1) according to some embodiments. Transcoding is digital-to-digital conversion of one encoding to another. System 200 can include content owner 210, network 220, computing system 230, and repository 270. Content owner 210 can be a data store storing one or more films and be associated with the owner of the one or more films (e.g., film 100 in FIG. 1). Content owner 210 can communicate over network 220. Network 220 can be a telecommunications network, such as the internet. Network 220 is described further in relation to FIG. 6

Computing system 230 can include control 240, transcoder 250, and local disk 260. Computing system 230 can communicate over network 220 (e.g., with content owner 210). Transcoder 250 can encode and decode a digital file and/or data stream (e.g., video 120, audio 130, and timed text 140 of film 100 in FIG. 1). Local disk 260 is non-volatile storage (e.g., a hard disk drive, solid-state drive (SSD), and the like) inside computing system 230. Computing system 230 including local disk 260 is described further in relation to FIG. 6.

Repository 270 can be a data store storing one or more transcoded films. In some embodiments, repository 270 is cloud storage, where physical storage spans multiple servers (and often locations), and the physical environment is typically owned and managed by a hosting company. Cloud computing environments are described further in relation to FIG. 6.

According to various embodiments, control 240 requests and downloads a video file associated with a film (e.g., film 100 in FIG. 1) from content owner 210 over network 220. By way of non-limiting example, the video file (not depicted in FIG. 2) can be on the order of a hundred megabytes in size and (depending on the bandwidth of network 220) take on the order of tens of minutes to download. The video file can be written to local disk 260.

Control 240 can open the video file (stored on local disk 260) and send each frame of the video file to transcoder 250. As transcoder 250 generates a transcoded frame, each transcoded frame can be saved to local disk 260 in a separate file. Depending on the number of frames (e.g., a function of the length of the film), there can be on the order of hundreds of thousands of discrete files. Once all the frames of the video file are transcoded, control 240 can read each transcoded frame file individually to assemble a transcoded video file. The transcoded video file can be uploaded to repository 270. The transcoded video file can be on the order of a hundred megabytes in size and (depending on the bandwidth of network 220) take on the order of tens of minutes to download.

System 200 can be inefficient, because of the time required to download the entire video file from content owner 210 to computing system 230 (and storing it on local disk 260), writing hundreds of thousands of transcoded frames in individual files to local disk 260, assembling and writing to local disk 260 the transcoded video file by individually reading the transcoded frame files, and then uploading the transcoded video file to repository 270. Having hundreds of thousands of discrete files in a directory on local disk 260 can ruin local disk 260 performance, and just enumerating the directory alone can take on the order of several minutes. Since local disk 260 has a fixed and finite capacity, there is a limit to the size of the video file computing system 230 can transcode.

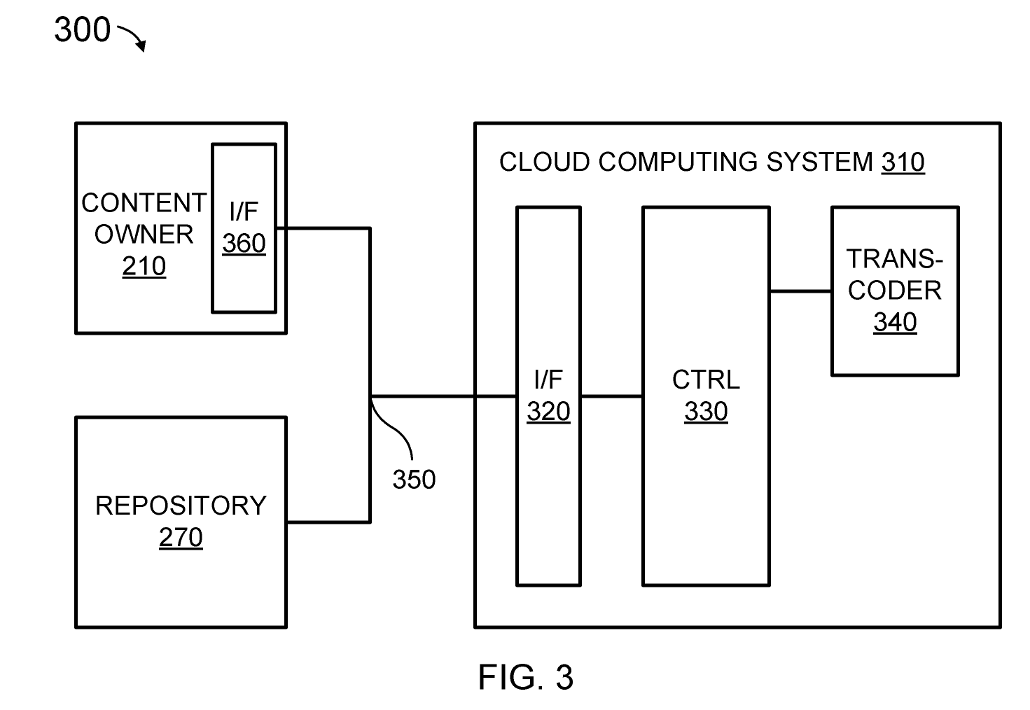

FIG. 3 illustrates system 300 for transcoding digital files (e.g., video 120, audio 130, and timed text 140 of film 100 in FIG. 1) according to various embodiments. System 300 can include content owner 210, network 350, cloud computing system 310, and repository 270. Content owner 210 and repository 270 were described above in relation to FIG. 2. Content owner 210 can include network interface 360 for communicating over network 350.

Cloud computing system 310 can be (in) a cloud-based computing environment and include network interface 320, control 330, and transcoder 340. Network interface 320 can be used to communicate over network 350 (e.g., with content owner 210). Transcoder 340 can encode and decode a digital file and/or data stream (e.g., video 120, audio 130, and timed text 140 of film 100 in FIG. 1). Transcoder 340 can support multiple video and audio codecs, such as those described above in relation to FIG. 1. In some embodiments, transcoder 340 is FFmpeg. Other transcoders can be used for transcoder 340, such as Libav, MEncoder, and the like. Cloud-based computing environments are described further in relation to FIG. 6.

In some embodiments, transcoder 340 can be one or more instances of a transcoder in the cloud-based computing environment. For example, each instance of a transcoder can be run on a hardware server, virtual machine, container, and the like (not shown in FIG. 3). In various embodiments, control 330 can dispatch video frames (e.g., as the video frames are received in a stream from content owner 210) to multiple transcoder instances, such as in a round-robin manner. Other scheduling methods can be used. Control 330 can index each video frame, so that should the transcoded video frames be received from the transcoder instances out of chronological order, control 330 can rearrange the transcoded video frames in chronological sequence (e.g., by sequentially numbering the file names).

Network 350 can be a telecommunications network comprising various combinations and permutations of wired and wireless networks, such as a local area network (LAN), wireless local area network (WLAN), metropolitan area network (MAN), wide area network (WAN), Internet area network (IAN), and the like. In some embodiments, network 350 includes the Internet.

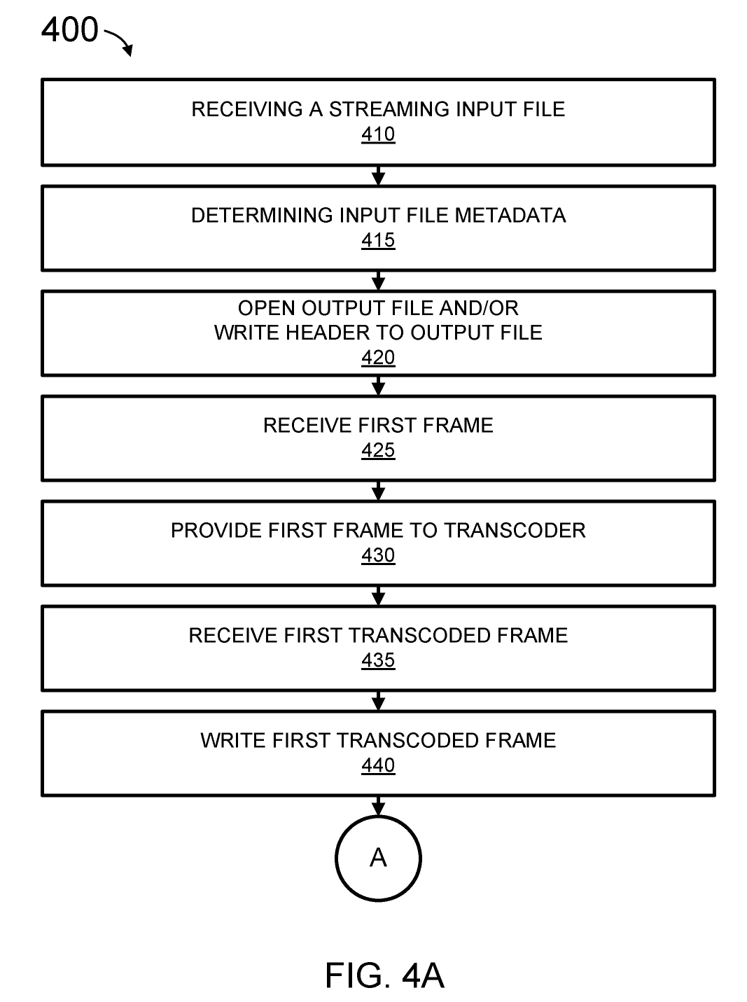

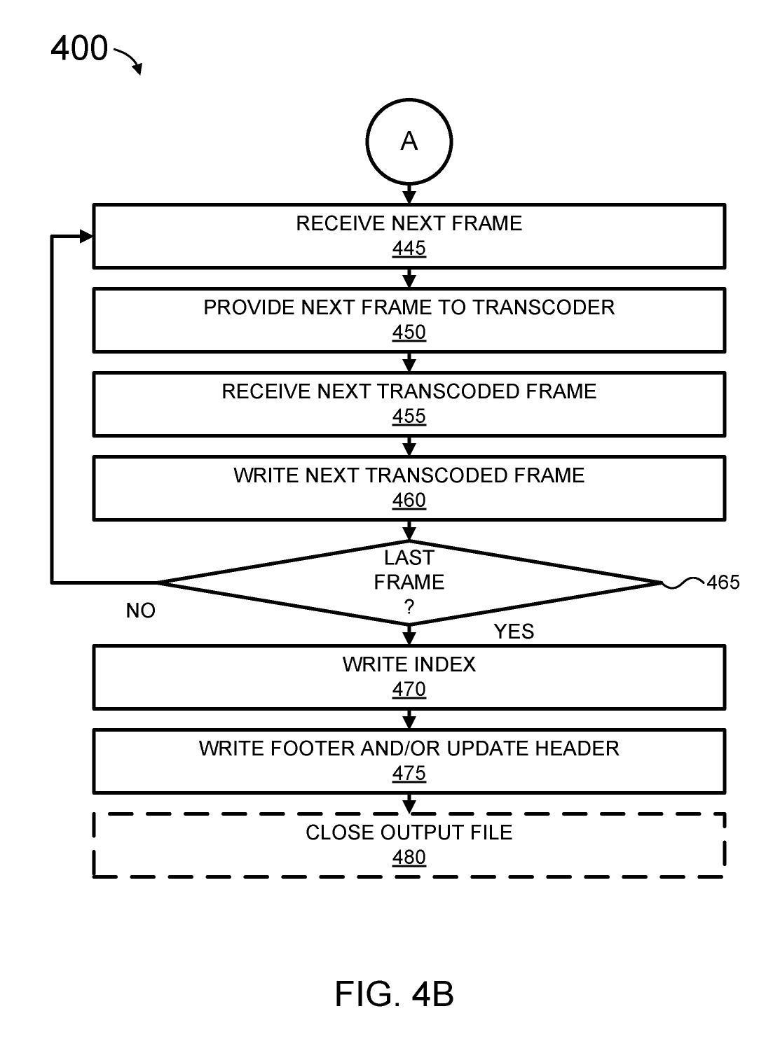

FIGS. 4A and 4B illustrate method 400 for transcoding digital files (e.g., video 120, audio 130, and timed text 140 of film 100 in FIG. 1), according to various embodiments. Method 400 can be performed by system 300 (FIG. 3). By way of example and not limitation, method 400 is described in relation to transcoding video files. Other types of digital files, such as audio, can be transcoded using method 400.

Method 400 can commence at step 410, where a streamed input file is received. For example, cloud computing system 310 requests a video file from content owner 210 (FIG. 3). In response to the request, content owner 210 can begin streaming (e.g., transmitting (or receiving) the video file over network 350 as a steady, continuous flow) the video file to cloud computing system 310. In some embodiments, the video file is a QuickTime container including video encoded using the Apple ProRes codec. Other combinations and permutations of containers and/or video codecs (e.g., described above in relation to FIG. 1) can be used.

At step 415, metadata concerning the requested input file can be determined. For example, the metadata can be determined from the beginning of the requested input file, such as by data (and/or metadata) at the start of the input file, from a file extension of the input file, and the like. Alternatively or additionally, the metadata can be received from a user of system 300.

The metadata can include the codec used to encode the video in the input file, size of the video (e.g., number of frames), frame rate, color space, resolution, color grading, and the like of the video The color space (also referred to as color model or color system) can be a mathematical model describing a range of colors as tuples of numbers (e.g., R′G′B′ encoding, Y′C_{B}C_{R} encoding, and the like). Frame rate can be the frequency at which frames in the video sequence are displayed (e.g., 60 Hz, 50 Hz, 30 Hz, 25 Hz, 24 Hz, and the like). Resolution of the video can be the number of distinct pixels in each dimension that can be displayed, such as 480i, 720p, 1080p, 4K UHD, 8K UHD, and the like. Color grading can be alteration and enhancement of the video color, such as color correction, generating artistic color effects, and the like.

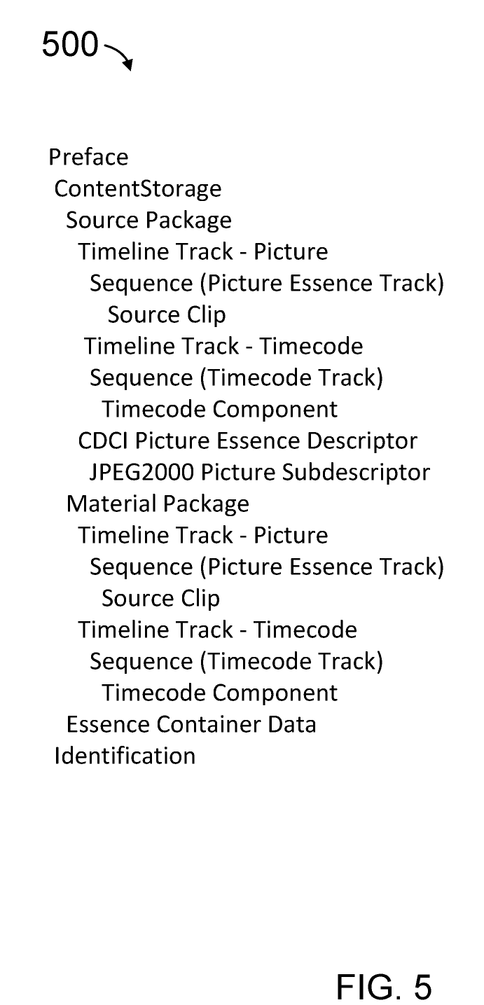

At step 420, an output file can be opened/made. For example, the output file can be a (new) file created in repository 270. In some embodiments, the output file is in the Material eXchange Format (XMF) and/or is in compliance with the Interoperable Master Format (IMF) standard developed by the Society of Motion Pictures and Television Engineers. Additionally, a header can be written to the output file. In some embodiments, the header can include metadata, such as the metadata determined at step 410. The header is described further in relation to FIG. 5.

At step 425, a first frame of the video in the input file can be received. For example, the first frame is received by network interface 350 from repository 270. For illustrative purposes, frame_count=1.

At step 430, the received first frame can be provided to a transcoder. For example, the received first frame is provided to transcoder 340 (FIG. 3). By way of further non-limiting example, instructions (e.g., an encoding of the received frame (e.g., source encoding), an encoding for the frame to be produced by the transcoder (destination encoding), and the like) are provided to the transcoder. In response, the transcoder can transcode the first frame. In some embodiments, the transcoder uses a JPEG 2000 (JP2) codec to generate the first transcoded frame. JPEG 2000 can use intra-frame compression (e.g., frames can be compressed independently from other frames), in contrast to some video codecs which use inter-frame compression (e.g., compression of a given frame depends on compression of other frames).

At step 435, a first transcoded frame can be received. For example, a transcoded first frame can be received from transcoder 340. By way of further non-limiting example, the first transcoded frame is the first received frame transcoded by transcoder 340.

At step 440, the first transcoded frame can be written to the output file. For example, the first transcoded frame can be written to the output file in repository 270.

At step 445, a next frame of the video in the input file can be received. For example, the next frame is received by network interface 350 from repository 270. For illustrative purposes, frame_count =frame_count+1.

At step 450, the received next frame can be provided to the transcoder. For example, the received next frame is provided to transcoder 340 (FIG. 3). By way of further non-limiting example, instructions (e.g., an encoding of the received frame (e.g., source encoding), an encoding for the frame to be produced by the transcoder (destination encoding), and the like) are provided to the transcoder. In response, the transcoder can transcode the next frame. In some embodiments, the transcoder uses a JPEG 2000 (JP2) codec to generate the next transcoded frame. Other (video) codecs can be used.

At step 455, a next transcoded frame can be received. For example, a transcoded next frame can be received from transcoder 340. By way of further non-limiting example, the next transcoded frame is the next received frame transcoded by transcoder 340.

At step 460, the next transcoded frame can be written to the output file. For example, the next transcoded frame is written (e.g., sequentially after the prior transcoded frame) to the output file in repository 270.

At step 465, whether the last frame has been received can be checked. In some embodiments, when the video stream (e.g., video streaming in response to the request of step 405) ends, the last frame has been received. For example, an indication that the stream has ended, such as an end-of-file indication, can be received. When the last frame has not been received, method 400 proceeds to step 445. When the last frame has been received, method 400 proceeds to step 470.

At step 470, an index can be written to the output file. For example, the index is written (e.g., sequentially after the last transcoded frame) to the output file in repository 270. In some embodiments, the index denotes a location for every transcoded frame in the output file. For example, the index includes a byte offset for each transcoded frame in the output file.

At step 475, a footer can be written to the output file. For example, the footer is written (e.g., sequentially after the index) to the output file in repository 270. In some embodiments, the footer includes at least some of the information in the header. The footer is described further in relation to FIG. 5. Additionally or alternatively, the header can be updated with a position of the footer. For example, a byte offset of the footer can be included in the header.

At step 480, the output file can optionally be closed. For example, an indication that the output file is complete can be sent to repository 270. In response to the close file indication, (an operating system of) repository 270 can record information about the output file, such as the type, size, date/time of creation, date/time of most recent modification, permissions (e.g., full Control, modify, read, and write), author identity, and the like.

In embodiments where method 400 produces an XMF file including one video essence (track), the produced XMF format can be included with other (e.g., video and/or audio) essences in an Interoperable Master Format (IMF) package. IMF is a standard of the Society of Motion Picture Television Engineers.

As illustrated by method 400, system 300 can be more efficient than system 200. For example, method 400 can begin transcoding before the entire video file is downloaded, skips writing each transcoded frame as a discrete file on local disk, and can start writing the transcoded video file to the repository before all the frames are transcoded. Since transcoded frames are written to the output file in the repository (e.g., scalable cloud storage), the size of the film that can be transcoded is not limited by the fixed size of a local disk.

FIG. 5 illustrates an XMF header and/or footer 500 having a tree-structure according to some embodiments.

FIG. 6 illustrates an exemplary computer system 600 that may be used to implement some embodiments of the present invention. The computer system 600 in FIG. 6 may be implemented in the contexts of the likes of computing systems, networks, servers, or combinations thereof. The computer system 600 in FIG. 6 includes one or more processor unit(s) 610 and main memory 620. Main memory 620 stores, in part, instructions and data for execution by processor unit(s) 610. Main memory 620 stores the executable code when in operation, in this example. The computer system 600 in FIG. 6 further includes a mass data storage 630, portable storage device 640, output devices 650, user input devices 660, a graphics display system 670, and peripheral device(s) 680.

The components shown in FIG. 6 are depicted as being connected via a single bus 690. The components may be connected through one or more data transport means. Processor unit(s) 610 and main memory 620 are connected via a local microprocessor bus, and the mass data storage 630, peripheral device(s) 680, portable storage device 640, and graphics display system 670 are connected via one or more input/output (I/O) buses.

Mass data storage 630, which can be implemented with a magnetic disk drive, solid state drive, or an optical disk drive, is a non-volatile storage device for storing data and instructions for use by processor unit(s) 610. Mass data storage 630 stores the system software for implementing embodiments of the present disclosure for purposes of loading that software into main memory 620.

Portable storage device 640 operates in conjunction with a portable non-volatile storage medium, such as a flash drive, floppy disk, compact disk, digital video disc, or Universal Serial Bus (USB) storage device, to input and output data and code to and from the computer system 600 in FIG. 6. The system software for implementing embodiments of the present disclosure is stored on such a portable medium and input to the computer system 600 via the portable storage device 640.

User input devices 660 can provide a portion of a user interface. User input devices 660 may include one or more microphones, an alphanumeric keypad, such as a keyboard, for inputting alphanumeric and other information, or a pointing device, such as a mouse, a trackball, stylus, or cursor direction keys. User input devices 660 can also include a touchscreen. Additionally, the computer system 600 as shown in FIG. 6 includes output devices 650. Suitable output devices 650 include speakers, printers, network interfaces, and monitors.

Graphics display system 670 include a liquid crystal display (LCD) or other suitable display device. Graphics display system 670 is configurable to receive textual and graphical information and processes the information for output to the display device.

Peripheral device(s) 680 may include any type of computer support device to add additional functionality to the computer system.

The components provided in the computer system 600 in FIG. 6 are those typically found in computer systems that may be suitable for use with embodiments of the present disclosure and are intended to represent a broad category of such computer components that are well known in the art. Thus, the computer system 600 in FIG. 6 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX, ANDROID, IOS, CHROME, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computing system 600 may be implemented as a cloud-based computing environment, such as a virtual machine operating within a computing cloud. In other embodiments, the computing system 600 may itself include a cloud-based computing environment, where the functionalities of the computing system 600 are executed in a distributed fashion. Thus, the computing system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computing system 600, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical, magnetic, and solid-state disks, such as a fixed disk. Volatile media include dynamic memory, such as system random-access memory (RAM). Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a programmable read-only memory (PROM), an erasable programmable read-only memory (EPROM), an electrically erasable programmable read-only memory (EEPROM), a Flash memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as JAVA, SMALLTALK, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of wired and/or wireless network, including a (wireless) local area network (LAN/WLAN) or a (wireless) wide area network (WAN/WWAN), or the connection may be made to an external computer (for example, through the Internet using an Internet Service Provider, wireless Internet provider, and the like).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

The following listing of the claims replaces all previous listings of the claims:

1. A method for transcoding a streaming video file comprising:
receiving a video file streamed from a content owner over a network, the streaming video file being encoded using a first codec;
determining metadata of the streaming video file;
creating an output file in cloud storage;
writing a header to the output file;
receiving a frame of the streaming video file from a network interface;
providing the frame to a transcoder, the transcoder decoding the frame using the first codec and encoding the frame using a second codec to generate a transcoded frame before the video file in its entirety is downloaded;
receiving the transcoded frame from the transcoder;
writing the transcoded frame to the output file;
receiving another frame of the streaming video file from the network interface;
providing the another frame to the transcoder, the transcoder decoding the another frame using the first codec and encoding the another frame using the second codec to generate another transcoded frame;
receiving the another transcoded frame from the transcoder;
writing the another transcoded frame to the output file;
determining the another frame is a last frame of the streaming video file;
writing an index to the output file;
writing a footer to the output file; and
updating the header in the output file, wherein the header has a tree structure and includes a color space, a resolution, and a color grading of the streaming video file.

2. The method of claim 1, wherein:
the metadata includes an identification of the first codec; and
the identification of the first codec is provided to the transcoder for the decoding.

3. The method of claim 2, wherein the output file is in the Material eXchange Format in accordance with the Interoperable Master Format standard.

4. (canceled)

5. The method of claim 1, wherein the index includes a byte offset for each of a plurality of transcoded frames, the plurality of transcoded frames including the first transcoded frame and the another transcoded frame.

6. The method of claim 5, wherein the footer includes at least some of the information in the header.

7. The method of claim 6, wherein updating the header includes adding a byte offset of the footer.

8. The method of claim 7, wherein the transcoder is FFmpeg.

9. The method of claim 8, wherein the first codec is any codec.

10. The method of claim 9, wherein the last frame is determined using an indication communication from the content owner that the streaming video file has ended.

11. A system for transcoding a streaming video file comprising:
a cloud-based computing system having cloud storage and at least one processor coupled to a memory, the memory storing instructions executable by the at least one processor to perform a method, the method comprising:
receiving a video file streamed from a content owner over a network, the streaming video file being encoded using a first codec;
determining metadata of the streaming video file;
creating an output file in the cloud storage;
writing a header to the output file;
receiving a frame of the streaming video file from a network interface;
providing the frame to a transcoder, the transcoder decoding the frame using the first codec and encoding the frame using a second codec to generate a transcoded frame before the video file in its entirety is downloaded;
receiving the transcoded frame from the transcoder;
writing the transcoded frame to the output file;
receiving another frame of the streaming video file from the network interface;
providing the another frame to the transcoder, the transcoder decoding the another frame using the first codec and encoding the another frame using the second codec to generate another transcoded frame;
receiving the another transcoded frame from the transcoder;
writing the another transcoded frame to the output file;
determining the another frame is a last frame of the streaming video file;
writing an index to the output file;
writing a footer to the output file; and
updating the header in the output file, wherein updating the header includes adding a byte offset of the footer.

12. The system of claim 11, wherein:
the metadata includes an identification of the first codec; and
the identification of the first codec is provided to the transcoder for the decoding.

13. The system of claim 12, wherein the output file is in the Material eXchange Format in accordance with the Interoperable Master Format standard.

14. The system of claim 13, wherein the header has a tree structure and includes a color space, a resolution, and a color grading of the streaming video file.

15. The system of claim 14, wherein the index includes a byte offset for each of a plurality of transcoded frames, the plurality of transcoded frames including the first transcoded frame and the another transcoded frame.

16. The system of claim 15, wherein the footer includes at least some of the information in the header.

17. (canceled) .

18. The system of claim 11, wherein the transcoder is FFmpeg.

19. The system of claim 18, wherein the first codec is any codec.

20. The system of claim 19, wherein the last frame is determined using an indication communication from the content owner that the streaming video file has ended.

21. A method for transcoding a streaming video file using a plurality of transcoders in a cloud-based computing environment, the method comprising:
receiving a video file streamed from a content owner over a network, the streaming video file being encoded using a first codec;
determining metadata of the streaming video file;
creating an output file in cloud storage;
writing a header to the output file;
receiving a plurality of frames of the streaming video file from a network interface;
indexing each of the plurality of frames before transcoding in case any of the plurality of frames is transcoded out of chronological order;
providing each of the plurality of frames to a selected transcoder in the plurality of transcoders, the selected transcoder decoding each of the plurality of frames using the first codec and encoding each of the plurality of frames using a second codec to generate a plurality of transcoded frames;
receiving the plurality of transcoded frames from the selected transcoders in the plurality of transcoders;
rearranging any transcoded frames that are received out of sequence;
writing the plurality of transcoded frames to the output file;
determining if a frame of the plurality of frames is a last frame of the streaming video file;
writing an index to the output file;
writing a footer to the output file; and
updating the header in the output file, wherein the header has a tree structure and includes a color space, a resolution, and a color grading of the streaming video file.
